(19) United States
(12) Patent Application Publication
(10) Pub. No.: US 2007/0085948 A1
(43) Pub. Date: Apr. 19, 2007

(54) Transflective type liquid crystal display device having high transmission and wide viewing angle characteristics

(75) Inventors: Wan Cheol Kim, Kyoungki-do (KR); Dong Hae Suh, Seoul (KR); Young Il Park, Seoul (KR)

Correspondence Address: SEYFARTH SHAW LLP, 131 S. DEARBORN ST., SUITE2400, CHICAGO, IL, 60603-5803, US

(73) Assignee: Boe Hydis Technology Co., Ltd.

(21) Appl. No.: 11/367,612

(22) Filed: Mar. 3, 2006

(30) Foreign Application Priority Data
Oct. 14, 2005 (KR) 10-2005-0096890

(51) Int. Cl. G02F 1/1335

(52) U.S. Cl. 349/114

(57) ABSTRACT

Disclosed is a transflective type LCD device having high transmission and wide viewing angle characteristics. The transflective type LCD device includes first and second substrates aligned in opposition to each other, reflecting and transparent electrodes formed on one surface of the first substrate, a lower polarizing plate formed on the above electrodes, a lower alignment layer aligned on the lower polarizing plate, a color filter formed on one surface of the second substrate, a transparent common electrode formed on the color filter, an upper alignment layer formed on the transparent common electrode, two retardation films sequentially attached to an outer portion of the second substrate, an upper polarizing plate attached to the retardation films, and a liquid crystal layer including a plurality of liquid crystal molecules interposed between the first and second substrates.

### BACKGROUND OF THE INVENTION

1. Field of the Invention

The present invention relates to a transflective type liquid crystal display (LCD) device. More particularly, the present invention relates to a transflective type LCD device having high transmission and wide viewing angle characteristics.

2. Description of the Prior Art

As generally known in the art, LCD devices are classified into transmissive LCD devices using backlight units as light sources thereof and reflective LCD devices using natural light as light sources thereof. Since the transmissive LCD device employs the backlight unit to generate light, it can display bright images in dark places. However, such a backlight unit may increase power consumption of the transmissive LCD device. In contrast, the reflective LCD uses natural light as a light source without employing the backlight unit, so it can display images with low power consumption. However, the reflective LCD device cannot be used in dark places.

To solve the above problems of the transmissive and reflective LCD devices, transflective type LCD devices have been suggested. The transflective type LCD device can be selectively used as a transmissive LCD device or a reflective LCD device depending on environment thereof, so it can display images with relatively low power consumption in bright places while displaying images by using the backlight unit in dark places.

FIG. 1 is a sectional view illustrating a conventional transflective type LCD device.

As shown in FIG. 1, the conventional transflective type LCD device includes an array substrate 10, a color filter substrate 20 aligned in opposition to the array substrate 10, and a liquid crystal layer 30 including liquid crystal molecules 32 interposed between the array substrate 10 and the color filter substrate 20.

The array substrate 10 has a lower glass substrate 11 formed at an upper surface thereof with a reflecting electrode 12 and a transparent electrode 13. A lower polarizing plate 14 is formed over the entire surface of the lower glass substrate 11 including the reflecting electrode 12 and the transparent electrode 13. In addition, a lower alignment layer 15 is formed on the lower polarizing plate 14.

The color filter substrate 20 has an upper glass substrate 21 formed at a lower surface thereof with a color filter 22. A transparent common electrode 23 is formed on the color filter 22 and an upper alignment layer 24 is formed on the transparent common electrode 23. In addition, an upper polarizing plate 25 is attached to an upper surface of the upper glass substrate 21.

According to the conventional transflective type LCD device having the above structure, the lower polarizing plate 14 is accommodated in the array substrate 10 between the lower alignment layer 15 and the reflecting electrode 12, so the conventional transflective type LCD device can be fabricated with a single cell gap. In addition, it is possible to improve transmittance by employing a 90° TN (twisted nematic) mode.

In general, a retardation film is provided in the array substrate and the color filter substrate of the transflective type LCD device in order to improve the viewing angle characteristic of the transflective type LCD device. However, according to the conventional transflective type LCD device, the lower polarizing plate is coated on the lower glass substrate of the array substrate, so that it is difficult to attach the retardation film to the inner portion of the lower glass substrate.

Of course, the retardation film can be attached to the color filter substrate. However, in this case, the light compensation may be achieved along one direction only. That is, the light compensation may not be achieved in a direction perpendicular to the one direction, so that the viewing characteristics may be degraded (SID 04′, PP. 1106-1109).

### SUMMARY OF THE INVENTION

Accordingly, the present invention has been made to solve the above-mentioned problems occurring in the prior art, and an object of the present invention is to provide a transflective type LCD device capable of improving the viewing angle characteristic even if a polarizing plate is accommodated in an array substrate.

In order to accomplish the above object, according one aspect of the present invention, there is provided a transflective type liquid crystal display (LCD) device comprising: first and second substrates aligned in opposition to each other; reflecting and transparent electrodes formed on one surface of the first substrate while facing the second substrate; a lower polarizing plate formed on the reflecting and transparent electrodes; a lower alignment layer aligned on the lower polarizing plate; a color filter formed on one surface of the second substrate while facing the first substrate; a transparent common electrode formed on the color filter; an upper alignment layer formed on the transparent common electrode; two retardation films sequentially attached to an outer portion of the second substrate; an upper polarizing plate attached to an outer surface of an outer retardation film of the two retardation films; and a liquid crystal layer including a plurality of liquid crystal molecules interposed between the first and second substrates.

According to the preferred embodiment of the present invention, a transmission axis of the lower polarizing plate crosses a transmission axis of the upper polarizing plate at an angle of 90±3°.

The retardation film consists of disc-shaped liquid crystal molecules and optical transmission axes of the two retardation films cross each other at an angle of 90±3°.

The rubbing angle of the lower alignment layer is −45±3° and the rubbing angle of the upper alignment layer is 45±3°.

The rubbing direction of the lower alignment layer crosses a transmission axis of the lower polarizing plate at an angle of 0±3°.

An optical transmission axis of an upper retardation film aligned at an outer portion of the second substrate corresponds to a rubbing direction of the lower alignment layer, and an optical transmission axis of a lower retardation film aligned on the upper polarizing plate corresponds to a rubbing direction of the upper alignment layer.

An optical phase retardation value of the retardation film in a vertical direction is 50 to 200 nm and an average inclination angle of disc-shaped liquid crystal molecules is 0 to 30° when a wavelength of light is 550 nm±10 nm.

The liquid crystal layer consists of TN liquid crystal molecules and dΔ n of the liquid crystal molecule is approximately 0.30 to 0.50 μm when a wavelength of light is 550 nm±10 nm.

According to second aspect of the present invention, there is provided a transflective type liquid crystal display (LCD) device comprising: first and second substrates aligned in opposition to each other; reflecting and transparent electrodes formed on one surface of the first substrate while facing the second substrate; a lower polarizing plate formed on the reflecting and transparent electrodes; a lower alignment layer aligned on the lower polarizing plate; a color filter formed on one surface of the second substrate while facing the first substrate; a transparent common electrode formed on the color filter; an upper alignment layer attached to an upper surface of the transparent common electrode; two retardation films sequentially attached to the upper polarizing plate; an upper polarizing plate aligned on an outer surface of an outer retardation film of the two retardation films; and a liquid crystal layer including a plurality of liquid crystal molecules interposed between the first and second substrates.

Herein, a transmission axis of the lower polarizing plate crosses a transmission axis of the upper polarizing plate at an angle of 90±3°.

The retardation film consists of disc-shaped liquid crystal molecules and optical transmission axes of the two retardation films cross each other at an angle of 90±3°.

A rubbing angle of the lower alignment layer is −45±3° and a rubbing angle of the upper alignment layer is 45±3°.

A rubbing direction of the lower alignment layer crosses a transmission axis of the lower polarizing plate at an angle of 90±3°.

An optical transmission axis of an upper retardation film aligned below the upper polarizing plate corresponds to a rubbing direction of the lower alignment layer, and an optical transmission axis of a lower retardation film aligned on the upper alignment layer corresponds to a rubbing direction of the upper alignment layer.

An optical phase retardation value of the retardation film in a vertical direction is 50 to 200 nm and an average inclination angle of disc-shaped liquid crystal molecules is 0 to 30° when a wavelength of light is 550 nm±10 nm.

The liquid crystal layer consists of TN liquid crystal molecules, and dΔ n of the liquid crystal molecule is approximately 0.30 to 0.50 μm when a wavelength of light is 550 nm±10 nm.

In addition, the rubbing angle of the lower alignment layer is −45±3°, the rubbing direction of the lower alignment layer crosses the transmission axis of the lower polarizing plate at an angle of 90±3°, the rubbing angle of the upper alignment layer is 45±3°, and the rubbing direction of the upper alignment layer crosses the transmission axis of the upper polarizing plate at an angle of 90±3°.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating a conventional transflective type LCD device;

FIG. 2 is a sectional view illustrating a transflective type LCD device according to one embodiment of the present invention;

FIG. 3 is a view illustrating a retardation film used in a transflective type LCD device according to one embodiment of the present invention;

FIG. 4 is a view illustrating the structure of a retardation film and a TN-liquid crystal cell in a transflective type LCD device according to one embodiment of the present invention;

FIG. 5 is a perspective view illustrating a transmission axis of a polarizing plate, optical transmission axes of retardation films, and rubbing directions of upper and lower alignment layers in a transflective type LCD device according to one embodiment of the present invention;

FIG. 6 is a view for explaining viewing angle characteristics of a transflective type LCD device according to one embodiment of the present invention;

FIG. 7 is a sectional view illustrating a transflective type LCD device according to another embodiment of the present invention; and

FIG. 8 is a perspective view illustrating a transmission axis of a polarizing plate, optical transmission axes of retardation films, and rubbing directions of upper and lower alignment layers in a transflective type LCD device according to another embodiment of the present invention.

### DETAILED DESCRIPTION OF THE PREFERRED EMBODIMENTS

Hereinafter, preferred embodiments of the present invention will be described with reference to accompanying drawings.

First, the technical principle of the present invention will be briefly explained. According to the present invention, when a lower polarizing plate is accommodated in an array substrate, two retardation films using disc-shaped liquid crystal molecules are aligned below an upper polarizing plate of a color filter substrate in such a manner that optical transmission axes of two retardation films cross each other at an angle of 90±3°. Herein, the optical transmission axes of two retardation films are obtained by averaging optical transmission axes of liquid crystal molecules provided in the retardation films.

In this case, the light compensation can be achieved not only along one direction, but also in a direction perpendicular to the one direction. Thus, it is possible to improve viewing angle characteristics of a transflective liquid crystal display (LCD) device.

Therefore, the transflective LCD device according to the present invention may represent high transmittance because the lower polarizing plate is accommodated in the array substrate and can improve the viewing angle characteristics because two retardation films having optical transmission axes crossing each other are aligned in the color filter substrate.

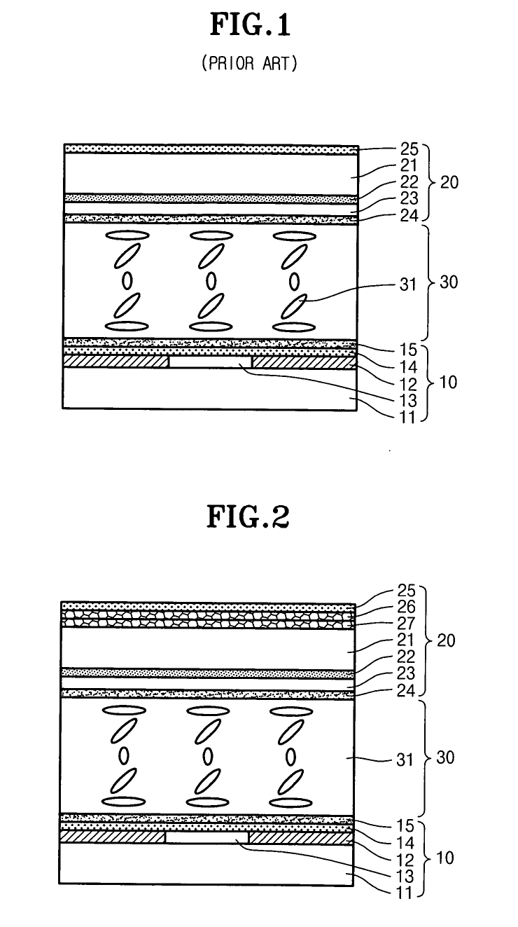

FIG. 2 is a sectional view illustrating the transflective type LCD device according to one embodiment of the present invention. Hereinafter, the present invention will be described in detail with reference to FIG. 2. It should be noted that the same reference numerals are used to refer to the same elements in FIG. 1 and FIG. 2.

As shown in FIG. 2, the transflective type LCD device of the present invention includes an array substrate 10, a color filter substrate 20 aligned in opposition to the array substrate 10, and a liquid crystal layer 30 including liquid crystal molecules 32 interposed between the array substrate 10 and the color filter substrate 20.

The array substrate 10 has a lower glass substrate 11 formed at an upper surface thereof with a reflecting electrode 12 made of an opaque metal having superior reflectivity and a transparent electrode 13 made of a transparent metal, such as ITO. A lower polarizing plate 14 is formed over the entire surface of the lower glass substrate 11 including the reflecting electrode 12 and the transparent electrode 13. In addition, a lower alignment layer 15 is formed on the lower polarizing plate 14 in order to determine an initial alignment direction of the liquid crystal molecules when an electric field is not applied to the liquid crystal molecules.

The color filter substrate 20 has an upper glass substrate 21 formed at a lower surface thereof with an R, G, and B color filter 22 and a black matrix (not shown). A common electrode 23 is formed on the color filter 22. The common electrode 23 is made of a transparent metal, such as ITO, and generates an electric field together with the reflecting electrode 12 and the transparent electrode 13 of the array substrate 10. Similarly to the lower alignment layer 15, an upper alignment layer 24 is formed on the common electrode 23 in order to determine an initial alignment direction of the liquid crystal molecules when an electric field is not applied to the liquid crystal molecules. In addition, two retardation films 26 and 27 including disc-shaped liquid crystal molecules are attached to an upper surface of the upper glass substrate 21. An upper polarizing plate 25 is attached to an upper surface of the retardation film 26. The two retardation films 26 and 27 are fabricated by using liquid crystal having disc-shaped molecules, in which optical transmission axes of the two retardation films cross each other at an angle of 90±3°, thereby compensating for birefringence generated from upper and lower layers of a TN-liquid crystal cell.

The liquid crystal layer 30 consists of 90° TN liquid crystal molecules so as to improve transmittance thereof. Herein, dΔ n of the liquid crystal is approximately 0.30 to 0.50 μm when the wavelength of light is 550 nm±10 nm.

In the above structure, the lower polarizing plate 14 is accommodated in the array substrate 10 between the transparent electrode 13 and the lower alignment layer 15. Herein, the cell gap of a reflecting section having the reflecting electrode 12 is identical to the cell gap of a transmission section having the transparent electrode 13, so that the transflective LCD device has the high transmittance characteristic.

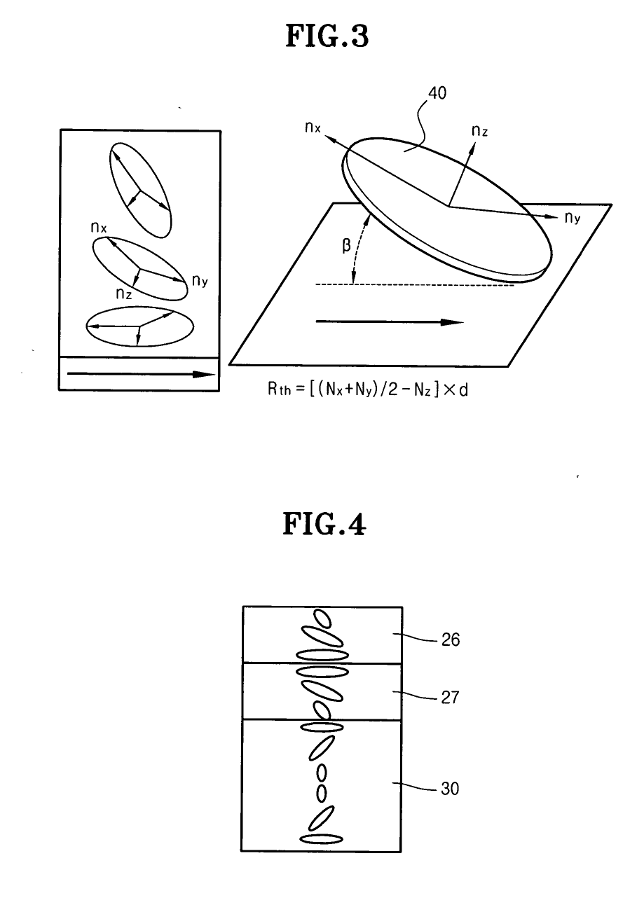

FIG. 3 is a view illustrating the retardation film used in the transflective type LCD device according to one embodiment of the present invention, in which arrows represent optical transmission axes obtained by averaging optical transmission axes of the disc-shaped liquid crystal molecules.

As shown in FIG. 3, the retardation film of the present invention can be obtained by continuously changing the alignment of disc-shaped liquid crystal molecules 40. That is, the disc-shaped liquid crystal molecules 40 are aligned such that the phase difference thereof with respect to the viewing angle can be continuously changed, thereby improving the viewing angle characteristics. The disc-shaped liquid crystal molecules 40 are horizontally aligned in the vicinity of a lower boundary area of the liquid crystal layer 30 while being vertically aligned in the vicinity of an upper boundary area of the liquid crystal layer 30.

The drawing provided on the right of FIG. 3 shows an equation for calculating a phase retardation value (Rₜₕ) in the vertical direction and an average inclination angle (β) of the disc-shaped liquid crystal molecules.
Rₜₕ[(Nx±Ny)/2−Nz]×d

For instance, according to the present invention, the phase retardation value (Rₜₕ) of the retardation film in the vertical direction is 50 to 200 nm when the wavelength of light is 550 nm±10 nm. At this time, the average inclination angle (β) of the disc-shaped liquid crystal molecules 40 is 0 to 30°.

FIG. 4 is a view illustrating the structure of the retardation film and the TN-liquid crystal cell in the transflective type LCD device according to one embodiment of the present invention.

If the voltage is applied to the TN-liquid crystal layer 30, some of liquid crystal molecules may be horizontally aligned at upper and lower positions of the TN-liquid crystal layer 30 in the vicinity of upper and lower substrates and some of liquid crystal molecules vertically aligned at the center portion of the TN-liquid crystal layer 30. The TN-liquid crystal layer 30 may present a phase difference because the alignment status of the liquid crystal molecules may vary depending on the viewing angle. Therefore, it is necessary to compensate for the phase difference by using the retardation film in order to improve viewing angle characteristics.

To this end, the transflective type LCD device according to the present invention includes two retardation films 26 and 27, which are aligned below the upper polarizing plate of the color filter substrate in such a manner that optical transmission axes of two retardation films 26 and 27 cross each other at an angle of 90±3°. At this time, the optical transmission axis of the upper retardation film 26 corresponds to the rubbing direction of the lower alignment layer of the array substrate, thereby compensating for the birefringence occurring in the lower liquid crystal layer of the TN-crystal layer 30. In addition, the optical transmission axis of the lower retardation film 27 corresponds to the rubbing direction of the upper alignment layer of the color filter substrate, thereby compensating for the birefringence occurring in the upper liquid crystal layer of the TN-crystal layer 30. Thus, the transflective type LCD device according to the present invention has a wide viewing angle characteristic.

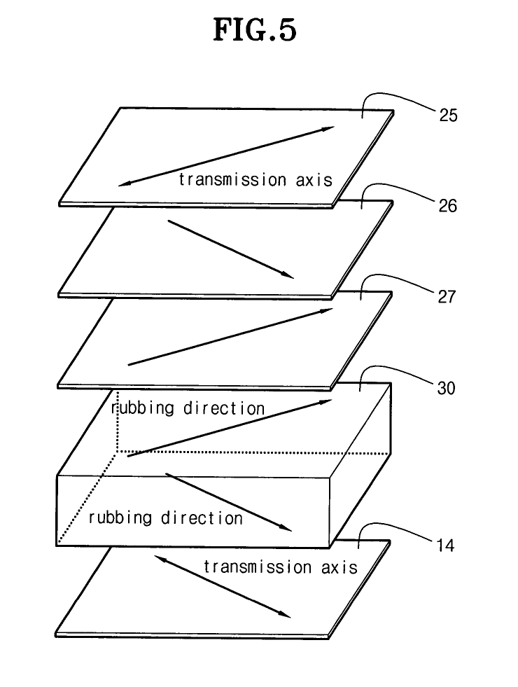

FIG. 5 is a perspective view illustrating a transmission axis of the polarizing plate, optical transmission axes of the retardation films, and rubbing directions of upper and lower alignment layers in the transflective type LCD device according to one embodiment of the present invention.

As shown in FIG. 5, the rubbing angle of the lower alignment layer of the array substrate is −45±3° and the rubbing angle of the upper alignment layer of the color filter substrate is −45±3°. At this time, the rubbing direction of the lower alignment layer is substantially identical to the optical transmission axis of the lower polarizing plate 14 within a tolerance of 0±3°.

The transmission axis of the upper polarizing plate 25 crosses the transmission axis of the lower polarizing plate 14 at an angle of 90±3°. In addition, the optical transmission axes of the two retardation films 26 and 27 may cross each other at an angle of 90±3°. At this time, the optical transmission axis of the upper retardation film 26 corresponds to the rubbing direction of the lower alignment layer of the array substrate, thereby compensating for the birefringence occurring in the lower liquid crystal layer of the TN-crystal layer 30. In addition, the optical transmission axis of the lower retardation film 27 corresponds to the rubbing direction of the upper alignment layer of the color filter substrate, thereby compensating for the birefringence occurring in the upper liquid crystal layer of the TN-crystal layer 30.

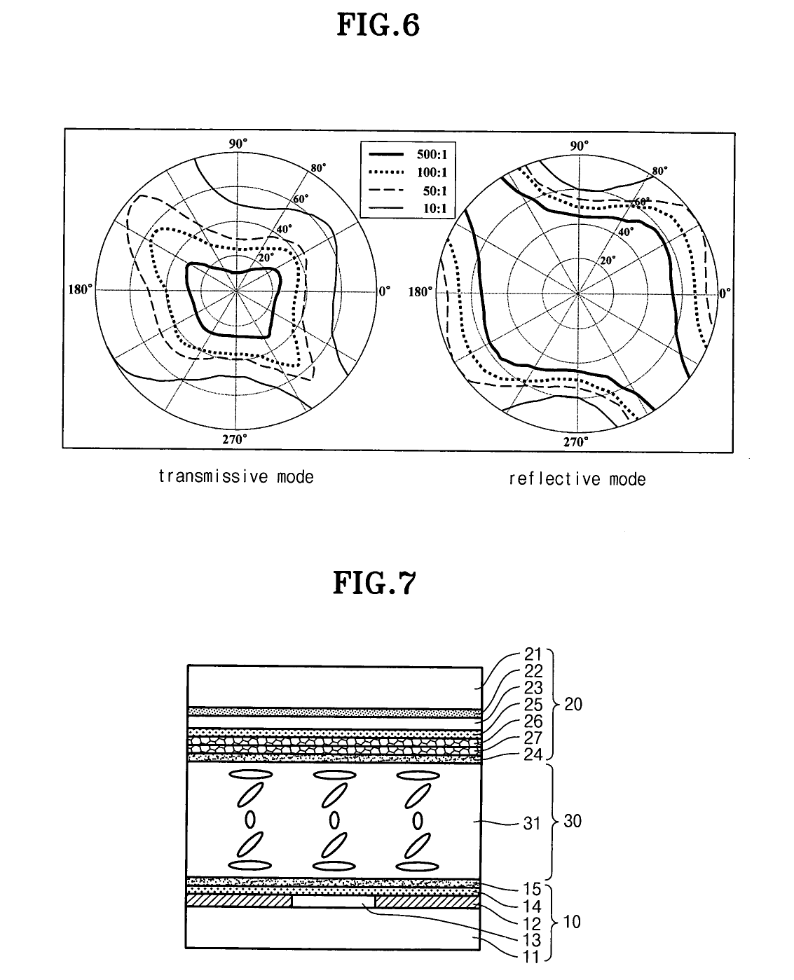

FIG. 6 shows simulation results illustrating the contrast ratio curve of the transmissive mode LCD device and the reflective mode LCD device for explaining viewing angle characteristics of the transflective type LCD device according to one embodiment of the present invention. The simulation is performed under the conditions of the incident light wavelength: 550 nm, dΔ n of the liquid crystal: 0.38 μm, the phase retardation (Rₜₕ) of the retardation film in the vertical direction: 137 nm, the average inclination angle of the disc-shaped liquid crystal molecules: 15.50, the rubbing angle of the lower alignment layer of the array substrate: −45°, and the rubbing angle of the upper alignment layer of the color filter substrate: 45°.

Referring to FIG. 6, the transmissive mode LCD device represents wide viewing angle characteristic of more than 110° in the horizontal direction and more than 100° in the vertical direction under the contrast ratio of 10. In addition, the reflective mode LCD device represents wide viewing angle characteristic of more than 160° in the horizontal direction and more than 120° in the vertical direction under the contrast ratio of 10.

Therefore, the transflective type LCD device can improve the viewing angle characteristics as well as the transmittance thereof by accommodating the lower polarizing plate in the array substrate and aligning two retardation films below the upper polarizing plate of the color filter substrate in such a manner that optical transmission axes of the two retardation films cross each other at an angle of 90±3°.

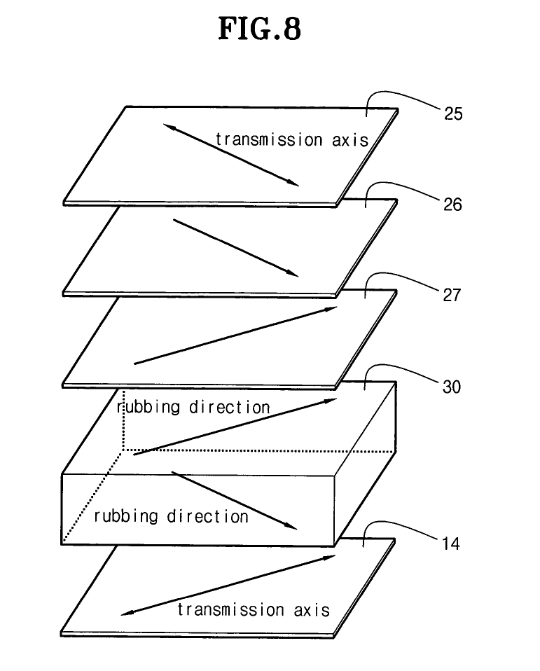

FIGS. 7 and 8 are views illustrating a transflective type LCD device according to another embodiment of the present invention, in which FIG. 7 is a sectional view of the transflective type LCD device, and FIG. 8 is a perspective view of the transflective type LCD device illustrating a transmission axis of a polarizing plate, optical transmission axes of retardation films, and rubbing directions of upper and lower alignment layers.

As shown in FIG. 7, according to another embodiment of the present invention, the upper polarizing plate 25 is accommodated in the color filter substrate 20 in opposition to the array substrate 10. In addition, two retardation films 26 and 27 are also accommodated in the color filter substrate 20 while being sequentially aligned below the upper polarizing plate 25 for the purpose of the light compensation.

In detail, according to another embodiment of the present invention, the color filter substrate 20 includes an upper glass substrate 21 formed at a lower surface thereof with a color filter 22 including a black matrix. In addition, a common electrode 23 is formed at a lower surface of the color filter 22 and the upper polarizing plate 25 is attached to a lower surface of the common electrode 23. The two retardation films 26 and 27 are sequentially aligned below the upper polarizing plate 25 in such a manner that optical transmission axes of the two retardation films 26 and 27 may cross each other at an angle of 90±3°. An upper alignment layer 24 is formed at a lower surface of the retardation film 27.

The array substrate 10 has a structure identical to that of the previous embodiment, so it will not be further described below.

Referring to FIG. 8, the transmission axis of the upper polarizing plate 25 of the color filter substrate may cross the transmission axis of the lower polarizing plate 14 accommodated in the array substrate 10 at an angle of 90±3°. The rubbing angle of the lower alignment layer of the array substrate is −45±3° and the rubbing angle of the upper alignment layer of the color filter substrate is 45±3°.

Different from the previous embodiment of the present invention, the rubbing direction of the lower alignment layer according to another embodiment of the present invention crosses the transmission axis of the lower polarizing plate at an angle of 90±3°. The optical transmission axis of the upper retardation film 26 aligned below the upper polarizing plate 25 may cross the rubbing direction of the upper alignment layer at an angle of 90±3°. In contrast, the optical transmission axis of the lower retardation film 27 may correspond to the rubbing direction of the upper alignment layer. Therefore, the birefringence occurring in the upper and lower liquid crystal layer of the TN-liquid crystal layer 30 can be compensated by means of the two retardation films 26 and 27.

As described above, the transflective type LCD device according to the present invention can effectively achieve the light compensation by accommodating the lower polarizing plate in the array substrate and aligning two retardation films below the upper polarizing plate of the color filter substrate in such a manner that optical transmission axes of the two retardation films cross each other at an angle of 90±3°. Therefore, the transflective type LCD device according to the present invention can represent the high transmittance by means of the lower polarizing plate accommodated in the array substrate and can improve the viewing angle characteristics by means of the two retardation films.

Although preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A transflective type liquid crystal display (LCD) device comprising:
first and second substrates aligned in opposition to each other;
reflecting and transparent electrodes formed on one surface of the first substrate while facing the second substrate;
a lower polarizing plate formed on the reflecting and transparent electrodes;
a lower alignment layer aligned on the lower polarizing plate;
a color filter formed on one surface of the second substrate while facing the first substrate;
a transparent common electrode formed on the color filter;
an upper alignment layer formed on the transparent common electrode;
two retardation films sequentially attached to an outer portion of the second substrate;
an upper polarizing plate attached to an outer surface of an outer retardation film of the two retardation films; and
a liquid crystal layer including a plurality of liquid crystal molecules interposed between the first and second substrates.

2. The transflective type LCD device as claimed in claim 1, wherein a transmission axis of the lower polarizing plate crosses a transmission axis of the upper polarizing plate at an angle of 90±3°.

3. The transflective type LCD device as claimed in claim 1, wherein the retardation film consists of disc-shaped liquid crystal molecules.

4. The transflective type LCD device as claimed in claim 1, wherein optical transmission axes of the two retardation films cross each other at an angle of 90±3°.

5. The transflective type LCD device as claimed in claim 1, wherein a rubbing angle of the lower alignment layer is −45±3° and a rubbing angle of the upper alignment layer is 45±3°.

6. The transflective type LCD device as claimed in claim 1, wherein a rubbing direction of the lower alignment layer crosses a transmission axis of the lower polarizing plate at an angle of 0±3°.

7. The transflective type LCD device as claimed in claim 1, wherein an optical transmission axis of an upper retardation film aligned at an outer portion of the second substrate corresponds to a rubbing direction of the lower alignment layer, and an optical transmission axis of a lower retardation film aligned on the upper polarizing plate corresponds to a rubbing direction of the upper alignment layer.

8. The transflective type LCD device as claimed in claim 1, wherein an optical phase retardation value of the retardation film in a vertical direction is 50 to 200 nm and an average inclination angle of disc-shaped liquid crystal molecules is 0 to 30° when a wavelength of light is 550 nm±10 nm.

9. The transflective type LCD device as claimed in claim 1, wherein the liquid crystal layer consists of TN liquid crystal molecules.

10. The transflective type LCD device as claimed in claim 1, wherein dΔ n of the liquid crystal molecule is approximately 0.30 to 0.50 μm when a wavelength of light is 550 nm±10 nm.

11. A transflective type liquid crystal display (LCD) device comprising:
first and second substrates aligned in opposition to each other;
reflecting and transparent electrodes formed on one surface of the first substrate while facing the second substrate;
a lower polarizing plate formed on the reflecting and transparent electrodes;
a lower alignment layer aligned on the lower polarizing plate;
a color filter formed on one surface of the second substrate while facing the first substrate;
a transparent common electrode formed on the color filter;
an upper alignment layer attached to an upper surface of the transparent common electrode;
two retardation films sequentially attached to the upper polarizing plate;
an upper polarizing plate aligned on an outer surface of an outer retardation film of the two retardation films; and
a liquid crystal layer including a plurality of liquid crystal molecules interposed between the first and second substrates.

12. The transflective type LCD device as claimed in claim 11, wherein a transmission axis of the lower polarizing plate crosses a transmission axis of the upper polarizing plate at an angle of 90±3°.

13. The transflective type LCD device as claimed in claim 11, wherein the retardation film consists of disc-shaped liquid crystal molecules.

14. The transflective type LCD device as claimed in claim 11, wherein optical transmission axes of the two retardation films cross each other at an angle of 90±3°.

15. The transflective type LCD device as claimed in claim 11, wherein a rubbing angle of the lower alignment layer is −45±3° and a rubbing angle of the upper alignment layer is 45±3°.

16. The transflective type LCD device as claimed in claim 11, wherein a rubbing direction of the lower alignment layer crosses a transmission axis of the lower polarizing plate at an angle of 90±3°.

17. The transflective type LCD device as claimed in claim 11, wherein an optical transmission axis of an upper retardation film aligned below the upper polarizing plate corresponds to a rubbing direction of the lower alignment layer, and an optical transmission axis of a lower retardation film aligned on the upper alignment layer corresponds to a rubbing direction of the upper alignment layer.

18. The transflective type LCD device as claimed in claim 11, wherein an optical phase retardation value of the retardation film in a vertical direction is 50 to 200 nm and an average inclination angle of disc-shaped liquid crystal molecules is 0 to 30° when a wavelength of light is 550 nm±10 nm.

19. The transflective type LCD device as claimed in claim 11, wherein the liquid crystal layer consists of TN liquid crystal molecules, and dΔ n of the liquid crystal molecule is approximately 0.30 to 0.50 μm when a wavelength of light is 550 nm±10 nm.

20. The transflective type LCD device as claimed in claim 11, wherein a rubbing angle of the lower alignment layer is −45±3°, a rubbing direction of the lower alignment layer crosses a transmission axis of the lower polarizing plate at an angle of 90±3°, a rubbing angle of the upper alignment layer is 45±3°, and a rubbing direction of the upper alignment layer crosses a transmission axis of the upper polarizing plate at an angle of 90±3°.
